(19) United States
(12) Patent Application Publication
(10) Pub. No.: US 2025/0122321 A1
(43) Pub. Date: Apr. 17, 2025

(54) FLUORINATED POLYBENZOXAZINE AND COMPOSITES THEREFROM

(71) Applicants: CASE WESTERN RESERVE UNIVERSITY, Cleveland, OH (US); Material Answers LLC, Weston, MA (US)

(72) Inventors: Hatsuo Ishida, Shaker Heights, OH (US); Christopher E. Scott, Weston, MA (US); Scott Allen Winroth, Groton, MA (US)

(21) Appl. No.: 18/738,700

(22) Filed: Jun. 10, 2024

Related U.S. Application Data
(60) Provisional application No. 63/507,214, filed on Jun. 9, 2023.

(51) Int. Cl. C08G 14/06

(52) U.S. Cl. CPC C08G 14/06

(57) ABSTRACT

A benzoxazine resin of structure (I), (II), or (III), wherein the fluorine content of the resin is about 15% by weight or higher.

### RELATED APPLICATION

This application claims priority from U.S. Provisional Application No. 63/507,214, filed Jun. 9, 2023, the subject matter of which is incorporated herein by reference in its entirety.

### GOVERNMENT FUNDING

This invention was made with support under 80NSSC21C0284 awarded by the National Aeronautics and Space Administration. The government has certain rights in the invention.

### FIELD OF THE INVENTION

The present invention is in the technical field of polymer compositions. More particularly, the present invention relates to benzoxazine compositions, composites therefrom, and their preparation.

### BACKGROUND

Polybenzoxazines are a class of thermosetting polymers that belong to the family of addition-curable phenolic resins. One type of benzoxazine includes monomers synthesized from different phenols and amines of varying backbone structures. Polybenzoxazines have gained interest because of their unique thermal and mechanical properties and their flexible synthesis chemistry that allows for compounds tailored to specific applications. The unique properties of polybenzoxazines originate from their hydrogen-bonded structures. Polymerization of benzoxazines can be achieved through the cationic ring opening of the oxazine ring, with or without an added initiator or catalyst. Another unique characteristic is that polybenzoxazines have greater molecular design flexibility than other polymers. They release no reaction by-product during polymerization, and no strong acid or alkaline catalysts are required for the synthesis of monomers or for polymerization. However, some acids, such a phenols and carboxylic acids, will accelerate the rate of polymerization. Furthermore, no volatiles are released and almost no shrinkage is experienced upon polymerization.

Polymers with reduced flammability are needed to meet regulations in a number of industries including transportation, aerospace, building and construction, consumer electronics, and electrical equipment. Flammability generally refers to the propensity of a substance to ignite easily and burn readily with a flame. Heat release capacity is a key measure of a polymer's flammability that can be performed using only milligram quantities of material. Standardized test methods, such as ASTM D7309 (Standard Test Method for Determining Flammability Characteristics of Plastics and Other Solid Materials Using Microscale Combustion calorimetry), establish standardized procedures for determining heat release capacity. ASTM D7309-20 defines heat release capacity as “the maximum specific heat release rate during a controlled thermal decomposition divided by the heating rate in the test.”

Heat release capacity is a useful parameter for screening and ranking the flammability of polymer materials. Work by the U.S. Federal Aviation Administration (FAA) has shown that heat release capacity is a good predictor of the fire response and flammability of polymers. Polymers with lower heat release capacities typically exhibit lower flammability. Heat release capacity has been correlated to other flammability tests such as Underwriters Laboratories test method UL 94 (Standard for Safety: Tests for Flammability of Plastic Materials for Parts in Devices and Appliances). Polymers with heat release capacities of about 300 J/g·K or less have been shown to exhibit self-extinguishing behavior when tested in accordance with UL 94. Polymers with a heat release capacity less than 100 J/g·K are typically found to have no ignition and no after-flame when tested in accordance with UL 94. There is a need for polymers and polymer composites with reduced flammability.

The glass transition temperature of a polymer is an important material property associated with its response to temperature. At temperatures above the glass transition temperature, the mechanical properties of the polymer are reduced. ASTM D883 (Standard Terminology Relating to Plastics) defines the glass transition as “the reversible change in an amorphous polymer or in amorphous regions of a partially crystalline polymer from (or to) a viscous or rubbery condition to (or from) a hard and relatively brittle one.” Polymers with high glass transition temperatures have the advantage of being useful in applications requiring materials that can withstand higher continuous service temperatures. There is a need for polymers and polymer composites with higher glass transition temperatures.

Satellites and other spacecraft in low Earth orbit (LEO) (between 140 and 970 km above the surface of the Earth) are exposed to harsh environmental conditions that include atomic oxygen, radiation (ultraviolet, x-ray, and galactic cosmic rays), micrometeoroids and debris. Atomic oxygen is formed from diatomic oxygen photodissociated by short wavelength ultraviolet radiation from the sun. Atomic oxygen erosion of polymers in LEO poses a serious threat to spacecraft performance and durability. There is a need for polymers with improved resistance to attack by oxygen and atomic oxygen erosion.

Polymers with the best resistance to atomic oxygen erosion typically have the following characteristics: 1) high fluorine content, 2) high density, and 3) produce non-oxidizable ash (the ash acts as a protective surface layer that reduces atomic oxygen fluence). Fluorinated polymers provide improved atomic oxygen erosion resistance compared to other types of polymers. A clear relationship of decreasing atomic oxygen erosion yield with increasing fluorine concentration has been identified among fluorinated polymers that have been tested in LEO aboard the International Space Station and in simulated ground-based testing using equipment such as a plasma asher. ASTM E2089 (Standard Practices for Ground Laboratory Atomic Oxygen Interaction Evaluation of Materials for Space Applications) defines atomic oxygen erosion yield as “the volume of material that is eroded by atomic oxygen per incident oxygen atom reported in cm³/atom.”

Approaches to improving atomic oxygen erosion resistance of polymers have included applying protective surface coatings and films. Coatings and films are commonly comprised of metals, metal oxides, silica (SiO₂), alumina (Al₂O₃), indium tin oxide (ITO), germanium, silicon, aluminum, and gold. Materials that are already in their highest oxidation state such as silicon dioxide and aluminum oxide do not react with the atomic oxygen in the LEO environment. Coatings are typically applied by sputter deposition or vapor deposition and range in thickness from a few tens of nm to greater than 100 nm. Protective coatings and films are prone to failure through microscopic surface defects. Surface defects can quickly lead to issues with undercutting erosion which can negatively affect reliability and performance of the coating.

There is a need in space and aerospace applications to minimize the weight and volume of spacecraft, vehicles, and habitats. High costs are associated with launches into space, especially heavy and/or large payloads. Reducing the mass of satellites, spacecraft, and launch vehicles can significantly reduce launch costs. There is a need for lightweight low flammability materials for use in spacecraft, vehicles, and habitats. There is also a need for lightweight atomic oxygen-resistant materials to replace aluminum in satellites and orbiting spacecraft. Aluminum experiences essentially zero atomic oxygen erosion; however, its density is significantly higher than most polymers and it must typically be machined to produce components for satellites and spacecraft. There is a need for lighter weight materials that can replace aluminum and reduce launch and fabrication costs.

Composite materials that are reinforced with continuous fibers are particularly advantageous for applications that require high strength and stiffness while maintaining low weight. A composite materials is defined by ASTM D3878 (Standard Terminology for Composite Materials) as “a substance consisting of two or more materials, insoluble in one another, which are combined to form a useful engineering material possessing certain properties not possessed by the constituents.” Continuous fiber composites are those that contain fibers, or filaments, with high aspect ratios. Aspect ratio refers to the ratio of fiber length to fiber diameter. Examples of continuous fiber reinforcements include unidirectional tows, woven fabrics, and helical windings. Ceramic fibers, such as those that include alumina (Al₂O₃) and silica (SiO₂), are particularly advantageous for use in spacecraft as they possess the combination of high strength, high modulus (stiffness), low flammability, and high atomic oxygen erosion resistance.

Composite materials often provide superior specific tensile strength and specific tensile modulus (stiffness) properties when compared to bulk materials. Specific strength refers to the tensile strength divided by the density of the material. Specific modulus refers to the tensile modulus divided by the density of the material.

U.S. Pat. No. 10,494,520 discloses organic sulfur acid-free compositions comprised of a benzoxazine compound, a phenolic compound, and a nitrogen-containing heterocyclic compound. The patent describes the use of a primary amine as an ingredient in the benzoxazine compound, including for example, aromatic mono- or di-amines such as aniline, furfurylamine, and 4,4′-diaminodiphenyl methane. The patent describes an embodiment where the phenolic compound is a difunctional phenolic compound. Examples of difunctional phenolic compounds are provided in the patent specification and include fluorinated difunctional phenolic compounds such as bisphenol AF. The patent discloses a composite article comprising bundles or layers of fibers infused with a curable benzoxazine composition and a method for production of such a composite. Methods for forming flame retarded composite articles are disclosed. Results from flammability, smoke, and toxicity (FST) testing are provided for two examples of composites that were prepared in accordance with the invention. The patent describes embodiments with glass transition temperatures that range from 109 to 147° C.

U.S. Pat. No. 10,538,648 discloses rubber compositions comprising a raw rubber and a main-chain benzoxazine. The patent teaches that the main-chain benzoxazine may be prepared by reacting a diphenol-based compound, an amine-based compound, and an aldehyde-based compound. The patent describes the possibility of using fluorinated diphenol-based compounds such as bisphenol AF. The patent further teaches that the diamine-based compound may be selected from a group of different amines and may include one or more amines in that group. The patent describes the possibility of using paraformaldehyde as the aldehyde-based compound.

### SUMMARY

Embodiments described herein include new classes of benzoxazine polymers that possess a unique combination of material properties superior to those of similar polymers disclosed in the prior art. The benzoxazine polymers also have the capacity for tuning of the property profile by means of post-cure heat treatment. The combination of temperature resistance, flame resistance, and oxidation resistance is particularly unique. The benzoxazine polymers can provide a superior combination of properties that is not achievable using current materials.

Other embodiments described herein include materials, resins, polymers, and composites including benzoxazine resin with fluorine in the chemical structure. Materials, resins, polymers, and composites including benzoxazine resin with fluorine in the chemical structure provide a variety of advantages, particularly in applications for which temperature resistance, degradation resistance, flame resistance, oxidation resistance and/or low surface energy are desirable.

Other embodiments described herein include polymers and composites with excellent mechanical properties suitable for structural applications.

Other embodiments include materials with high glass transition temperature to provide for temperature resistance.

Other embodiments include materials with low heat release capacity and/or low flammability.

Still other embodiments include materials with resistance to oxidation, including resistance to oxidation by atomic oxygen.

Other embodiments include materials with low surface energy.

Other embodiments include resins that can be used as matrices in composites with a variety of different reinforcing fibers including, for example, ceramic fibers, glass fibers, carbon fibers, and boron fibers.

In some embodiments, materials, resins, polymers, and composites described herein exhibit unexpectedly high glass transition temperatures. For example, some embodiments include polybenzoxazines wherein the glass transition temperature (Tg) is about 300° C. or higher. Other embodiments include polymers wherein the Tg is about 500° C. or higher.

In some embodiments, materials, resins, polymers, and composites described herein exhibit unexpectedly low heat release capacity. For example, some embodiments include polybenzoxazines wherein the heat release capacity is about 30 J/g. K or lower and preferably 10 J/g· K or lower.

Advantageously, the molecular structures of the resins described include fluorine in the structure. The presence of fluorine specifically provides for flame resistance, oxidation resistance, and low surface energy. Although the invention is not to be limited in scope by any theory, it is believed that the presence of fluorine in the chemical structure provides flame retardancy, especially in circumstances where the carbon-fluorine bond dissociates at a temperature close to or slightly below the main chain degradation temperature. Polymers with higher fluorine concentration are also generally more resistant to erosion by atomic oxygen.

In some embodiments, the molecular structures of the resins described herein can include one or more terminal reactive groups. The presence of these terminal reactive groups provides for high glass transition temperature and the ability to adjust the properties by post-cure heat treatment.

Exemplary benzoxazine resin embodiments are prepared from a diol, a diamine, a monoamine, and paraformaldehyde. The resin may be cured with or without catalyst to form a polymer. Composites may be prepared using the benzoxazine resin as the matrix and a variety of reinforcements. Of particular interest are composites prepared using fibers that are resistant to oxidative attack such as ceramic fibers or glass fibers.

These resins can be prepared by methods known in the art, for example, by reaction of a phenol with an amine in the presence of formaldehyde. The reaction may be accomplished in solution under reflux. Numerous phenols and amines suitable for the preparation of benzoxazines are known in the art. For example, the publications Handbook of Benzoxazine Resins (H. Ishida and T. Agag, Eds., 2011) and Advanced and Emerging Polybenzoxazine Science and Technology (H. Ishida and P. Froimowicz, Eds., 2017) disclose suitable chemicals. Mixtures of phenols may also be utilized. Similarly, mixtures of amines may also be utilized. The resins described herein will typically include various possible isomers and combinations thereof. In practice the resin molecular structure will include a mixture of isomers. In practice, a synthesized resin will include a mixture of molecular structures depending on the method used for its preparation.

### BRIEF DESCRIPTION OF THE DRAWING(S)

FIG. 1 is a TGA thermogram for poly(BAF-oda-fu).

FIG. 2 is a plot of microscale combustion calorimeter test results for poly(BAF-oda-fu) with specific heat release rate/heating rate plotted on the y-axis and temperature plotted on the x-axis.

FIG. 3 is an exploded assembly drawing of the vacuum bagging setup used in Examples 5, 7, and 12.

FIG. 4 is a dynamic mechanical analysis (DMA) thermogram for the carbon fiber composite sample described in Example 12 with no heat treatment.

FIG. 5 is a DMA thermogram for a carbon fiber composite sample that was heat treated up to 500° C., as described in Example 13.

### DETAILED DESCRIPTION

While the following terms are believed to be well understood by one of ordinary skill in the art, the following definitions are set forth to facilitate explanation of the presently disclosed subject matter.

As used herein, the verb “comprise” as is used in this description and in the claims and its conjugations are used in its non-limiting sense to mean that items following the word are included, but items not specifically mentioned are not excluded. The present invention may suitably “comprise”, “consist of”, or “consist essentially of”, the steps, elements, and/or reagents described in the claims.

Throughout the description, where compositions are described as having, including, or comprising, specific components, it is contemplated that compositions also consist essentially of, or consist of, the recited components. Similarly, where methods or processes are described as having, including, or comprising specific process steps, the processes also consist essentially of, or consist of, the recited processing steps. Further, it should be understood that the order of steps or order for performing certain actions is immaterial so long as the compositions and methods described herein remains operable. Moreover, two or more steps or actions can be conducted simultaneously.

As used herein, the term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length±15%, ±10%, ±9%, ±8%, ±7%, ±6%, ±5%, ±4%, ±3%, ±2%, or ±1% about a reference quantity, level, value, number, frequency, percentage, dimension, size, amount, weight or length.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

“Alkyl” or “alkyl group” refers to a fully saturated, straight or branched hydrocarbon chain radical having from one to twelve carbon atoms, and which is attached to the rest of the molecule by a single bond. Alkyls comprising any number of carbon atoms from 1 to 12 are included. An alkyl comprising up to 12 carbon atoms is a C₁-C₁₂ alkyl, an alkyl comprising up to 10 carbon atoms is a C₁-C₁₀ alkyl, an alkyl comprising up to 6 carbon atoms is a C₁-C₆ alkyl and an alkyl comprising up to 5 carbon atoms is a C₁-C₅ alkyl. A C₁-C₅ alkyl includes C₅ alkyls, C₄ alkyls, C₃ alkyls, C₂ alkyls and C₁ alkyl (i.e., methyl). A C₁-C₆ alkyl includes all moieties described above for C₁-C₅ alkyls but also includes C₆ alkyls. A C₁-C₁₀ alkyl includes all moieties described above for C₁-C₅ alkyls and C₁-C₆ alkyls, but also includes C₇, C₈, C₉ and C₁₀ alkyls. Similarly, a C₁-C₁₂ alkyl includes all the foregoing moieties, but also includes C₁₁ and C₁₂ alkyls. Non-limiting examples of C₁-C₁₂ alkyl include methyl, ethyl, n-propyl, i-propyl, sec-propyl, n-butyl, i-butyl, sec-butyl, t-butyl, n-pentyl, t-amyl, n-hexyl, n-heptyl, n-octyl, n-nonyl, n-decyl, n-undecyl, and n-dodecyl. Unless stated otherwise specifically in the specification, an alkyl group can be optionally substituted.

“Alkenyl” or “alkenyl group” refers to a straight or branched hydrocarbon chain radical having from two to twelve carbon atoms, and having one or more carbon-carbon double bonds. Each alkenyl group is attached to the rest of the molecule by a single bond. Alkenyl group comprising any number of carbon atoms from 2 to 12 are included. An alkenyl group comprising up to 12 carbon atoms is a C₂-C₁₂ alkenyl, an alkenyl comprising up to 10 carbon atoms is a C₂-C₁₀ alkenyl, an alkenyl group comprising up to 6 carbon atoms is a C₂-C₆ alkenyl and an alkenyl comprising up to 5 carbon atoms is a C₂-C₅ alkenyl. A C₂-C₅ alkenyl includes C₅ alkenyls, C₄ alkenyls, C₃ alkenyls, and C₂ alkenyls. A C₂-C₆ alkenyl includes all moieties described above for C₂-C₅ alkenyls but also includes C₆ alkenyls. A C₂-C₁₀ alkenyl includes all moieties described above for C₂-C₅ alkenyls and C₂-C₆ alkenyls, but also includes C₇, C₈, C₉ and C₁₀ alkenyls. Similarly, a C₂-C₁₂ alkenyl includes all the foregoing moieties, but also includes C₁₁ and C₁₂ alkenyls. Non-limiting examples of C₂-C₁₂ alkenyl include ethenyl(vinyl), 1-propenyl, 2-propenyl(allyl), iso-propenyl, 2-methyl-1-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-dodecenyl, 2-dodecenyl, 3-dodecenyl, 4-dodecenyl, 5-dodecenyl, 6-dodecenyl, 7-dodecenyl, 8-dodecenyl, 9-dodecenyl, 10-dodecenyl, and 11-dodecenyl. Unless stated otherwise specifically in the specification, an alkyl group can be optionally substituted.

“Aryl” refers to a hydrocarbon ring system radical comprising hydrogen, 6 to 18 carbon atoms and at least one aromatic ring. For purposes of this invention, the aryl radical can be a monocyclic, bicyclic, tricyclic or tetracyclic ring system, which can include fused or bridged ring systems. Aryl radicals include, but are not limited to, aryl radicals derived from phenyl(benzene), aceanthrylene, acenaphthylene, acephenanthrylene, anthracene, azulene, chrysene, fluoranthene, fluorene, as-indacene, s-indacene, indane, indene, naphthalene, phenalene, phenanthrene, pleiadene, pyrene, and triphenylene. Unless stated otherwise specifically in the specification, the term “aryl” is meant to include aryl radicals that are optionally substituted.

As used herein, the symbol

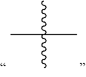

(hereinafter can be referred to as “a point of attachment bond”) denotes a bond that is a point of attachment between two chemical entities, one of which is depicted as being attached to the point of attachment bond and the other of which is not depicted as being attached to the point of attachment bond. For example,

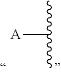

indicates that the chemical entity “A” is bonded to another chemical entity via the point of attachment bond. Furthermore, the specific point of attachment to the non-depicted chemical entity can be specified by inference. For example, the compound

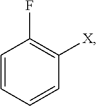

wherein X is

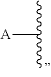

infers that the point of attachment bond is the bond by which X is depicted as being attached to the phenyl ring at the ortho position relative to fluorine.

Embodiments described herein include new classes of benzoxazine polymers that possess a unique combination of material properties superior to those of similar polymers disclosed in the prior art. The benzoxazine polymers also have the capacity for tuning of the property profile by means of post-cure heat treatment. The combination of temperature resistance, flame resistance, and oxidation resistance is particularly unique. The benzoxazine polymers can provide a superior combination of properties that is not achievable using current materials.

Embodiments described herein also include materials, resins, polymers, and composites including benzoxazine resin with fluorine in the chemical structure. Materials, resins, polymers, and composites including benzoxazine resin with fluorine in the chemical structure provide a variety of advantages, particularly in applications for which temperature resistance, degradation resistance, flame resistance, oxidation resistance and/or low surface energy are desirable.

In some embodiments, a benzoxazine resin described herein can have the chemical structure (I):

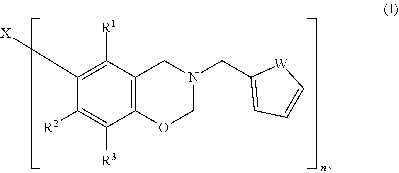

wherein
X includes at least one fluorine moiety;
n is equal to or greater than 1 and equal to or less than 4;
W is oxygen or sulfur; and
R¹, R², and R³ are each independently hydrogen, a halogen, an alkyl group, an alkyl group with one or more halogen substituents, an alkenyl group, an alkenyl group with one or more halogen substituents, an aryl group, or an aryl group with one or more halogen substituents.

The benzoxazine resin having structure (I) may be prepared by methods known in the art, for example, by the reaction of a phenol with either furfurylamine (where W is oxygen) or 2-thiophenemethylamine (where W is sulfur) in the presence of formaldehyde.

In some embodiments, the phenol may be multifunctional. For example, structure (I) with n=2 may be prepared using a bisphenol; structure (I) with n=3 may be prepared using a tri-functional phenol; and structure (I) with n=4 may be prepared using a tetra-functional phenol. In some embodiments, R¹, R², and R³ are each independently hydrogen, a halogen, a C₁-C₃ alkyl group, a C₁-C₃ alkyl group with one or more halogen substituents, a C₂-C₄ alkenyl group, a C₂-C₄ alkenyl group with one or more halogen substituents, a C₆-C₁₃ aryl group, or a C₆-C₁₃ aryl group with one or more halogen substituents.

In some embodiments, R¹, R², and R³ may all be the same or may each be different. For clarification, for a structure (I) with n=2 there are a total of six Rⁱ (corresponding to two sets of R¹, R², and R³); all of these Rⁱ may be the same, or they may each be different. Similarly, for a structure (I) with n=3 there are a total of nine Rⁱ (corresponding to three sets of R¹, R², and R³); all of these Rⁱ may be the same, or they may each be different.

Numerous phenols with at least one fluorine moiety may be used for the preparation of structure (I).

Examples of the moiety X corresponding to a monofunctional phenol (n=1) include the following: F; —CF₃; —OCF₃; and —(CF₂)ₘCF₃, where m is 1 to 10.

Examples of moiety X corresponding to a difunctional phenol (n=2) include the following: —C(CF₃)₂—; —(CF₂)ₘ—, where m is 1 to 10; and

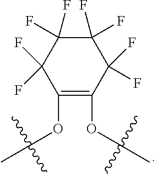 [SMILES: *OC1=C(O*)C(F)(F)C(F)(F)C(F)(F)C1(F)F]

Especially preferred examples of the moiety X include structures that correspond to bisphenols.

Preferably, R¹, R², and R³ are each independently hydrogen, a halogen, or fluorine.

In other embodiments, a benzoxazine resin described herein can have the chemical structure (II):

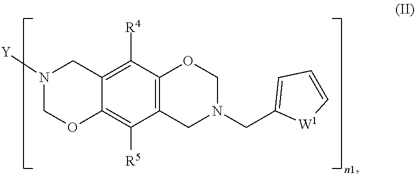

wherein
Y includes at least one fluorine moiety;
n1 is equal to or greater than 1 and equal to or less than 4;
W¹ is oxygen or sulfur; and
R⁴ and R⁵ are each independently hydrogen, a halogen, an alkyl group, an alkyl group with one or more halogen substituents, an alkenyl group, an alkenyl group with one or more halogen substituents, an aryl group, or an aryl group with one or more halogen substituents.

The benzoxazine resin having structure (II) may be prepared by methods known in the art, for example by the reaction of a primary amine with dihydroxybenzene and either 4-(2-furylmethyl) phenol (where W¹ is oxygen) or 4-(2-thiophenemethyl) phenol (where W¹ is sulfur) in the presence of formaldehyde. The amine may be multifunctional. For example, structure (II) with n1=2 may be prepared using a diamine; structure (II) with n1=3 may be prepared using a triamine; and structure (II) with n1=4 may be prepared using a tetra-functional amine.

In some embodiments, R⁴ and R⁵ are each independently hydrogen, a halogen, a C₁-C₃ alkyl group, a C₁-C₃ alkyl group with one or more halogen substituents, a C₂-C₄ alkenyl group, a C₂-C₄ alkenyl group with one or more halogen substituents, a C₆-C₁₃ aryl group, or a C₆-C₁₃ aryl group with one or more halogen substituents.

In some embodiments, R⁴ and R⁵ may be the same or they may each be different. For clarification, for a structure (II) with n1=2 there are a total of four Rⁱ (corresponding to two sets of R⁴ and R⁵); all of these Rⁱ may be the same, or they may each be different. Similarly, for a structure (II) with n1=3 there are a total of six Rⁱ (corresponding to three sets of R⁴ and R⁵); all of these Rⁱ may be the same, or they may each be different.

Numerous amines with at least one fluorine moiety may be used for the preparation of structure (II).

Examples of moiety Y corresponding to a monofunctional amine (n1=1) include the following:—CF₃; —(CF₂)ₘCF₃, where m is 1 to 10;

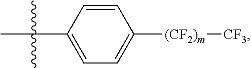

where m is 1 to 10; and

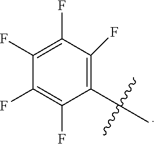 [SMILES: *c1c(F)c(F)c(F)c(F)c1F]

Examples of moiety Y corresponding to a difunctional amine (n1=2) include the following: —C(CF₃)₂—; —(CF₂)ₘ—, where m is 1 to 10;

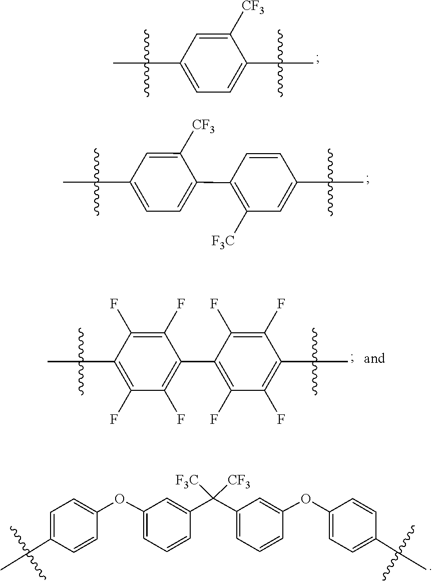

Preferably, R⁴ and R⁵ are each independently hydrogen, a halogen, or fluorine.

In other embodiments, a benzoxazine resin described herein can have the chemical structure (III):

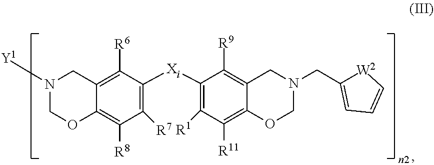

wherein
at least one of Y′ or Xi includes at least one fluorine moiety;
n2 is equal to or greater than 1 and equal to or less than 4;
W² is oxygen or sulfur; and
R⁶, R⁷, R⁸, R⁹, R¹⁰, and R¹¹ are each independently hydrogen, a halogen, an alkyl group, an alkyl group with one or more halogen substituents, an alkenyl group, an alkenyl group with one or more halogen substituents, an aryl group, or an aryl group with one or more halogen substituents.

The subscript i on the X moiety indicates that structure (III) encompasses structures where different moieties Xi may be present depending on the value of n2. For example, where n2=1 there is only one X moiety in the structure. Where n2=2, there are two X moieties in the structure, X₁ and X₂, which may be the same or may be different from each other. Similarly, where n2=3, there are three X moieties in the structure, X₁, X₂, and X₃, which may be the same or different. In the instance where n2=1 at least one of the moieties in the set {Y¹, X} includes at least one fluorine moiety. Similarly, in the instance where n2=3 at least one of the moieties in the set {Y¹, X₁, X₂, X₃} includes at least one fluorine moiety.

In some embodiments, R⁶, R⁷, R⁸, R⁹, R¹⁰, and R¹¹ are each independently hydrogen, a halogen, a C₁-C₃ alkyl group, a C₁-C₃ alkyl group with one or more halogen substituents, a C₂-C₄ alkenyl group, a C₂-C₄ alkenyl group with one or more halogen substituents, a C₆-C₁₃ aryl group, or a C₆-C₁₃ aryl group with one or more halogen substituents.

In some embodiments, R⁶, R⁷, R⁸, R⁹, R¹⁰, and R¹¹ may all be the same or they may each be different. For clarification, for a structure (III) with n2=2 there are a total of twelve Rⁱ (corresponding to two sets of R⁶, R⁷, R⁸, R⁹, R¹⁰, and R¹¹); all of these Rⁱ may be the same, or they may each be different. Similarly, for a structure (III) with n=3 there are a total of eighteen Rⁱ (corresponding to three sets of R⁶, R⁷, R⁸, R⁹, R¹⁰, and R¹¹); all of these Rⁱ may be the same, or they may each be different.

The benzoxazine resin having structure (III) may be prepared by methods known in the art, for example by the reaction of a primary amine with bisphenol(s) and either furfurylamine (where W² is oxygen) or 2-thiophenemethylamine (where W² is sulfur) in the presence of formaldehyde. The amine may be multifunctional. For example, structure (III) with n2=2 may be prepared using a diamine; structure (III) with n2=3 may be prepared using a triamine; and structure (III) with n2=4 may be prepared using a tetra-functional amine.

Numerous amines, including amines with or without a fluorine moiety, may be used for the preparation of structure (III).

Examples of moiety Y¹ corresponding to a monofunctional amine (n2=1) include the following: CF₃; —(CF₂)ₘCF₃, where m is 1 to 10;

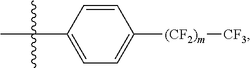

where m is 1 to 10;

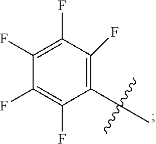 [SMILES: *c1c(F)c(F)c(F)c(F)c1F]

—(CH₂)ₘCH₃, where m is 1 to 5; —CH₂CH₂—(OCH₂CH₂)ₘ—CH₃, where m is 1 to 5;

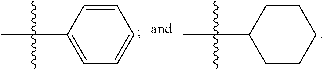 [SMILES: *c1ccccc1 ; *C1CCCCC1]

Examples of moiety Y¹ corresponding to a difunctional amine (n=2) include the following: —C(CF₃)₂—; —(CF₂)ₘ—, where m is 1 to 10;

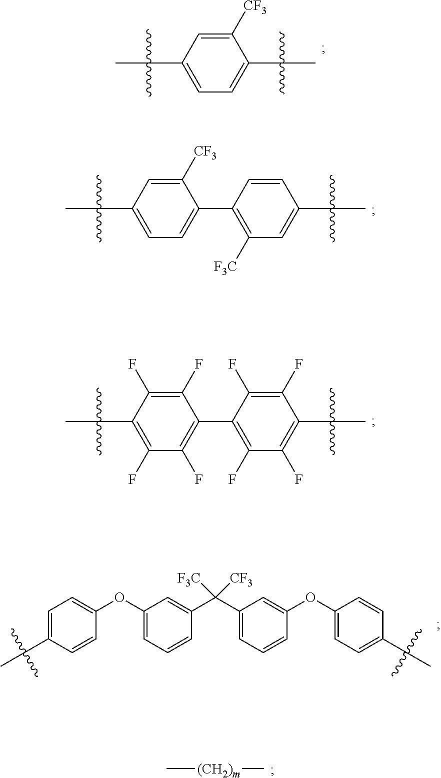

where m is 1 to 5; —(CH₂CH₂O)ₘ—CH₂CH₂—, where m is 1 to 5;

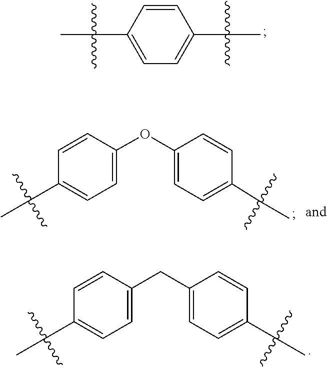 [SMILES: *c1ccc(*)cc1 ; *c1ccc(Oc2ccc(*)cc2)cc1 ; *c1ccc(Cc2ccc(*)cc2)cc1]

Numerous difunctional phenols, including bisphenols with or without a fluorine moiety, may be used for the preparation of structure (III).

Examples of moiety Xi include the following: —C(CF₃)₂—; —(CF₂)ₘ—, where m is 1 to 10:

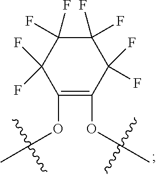 [SMILES: *OC1=C(O*)C(F)(F)C(F)(F)C(F)(F)C1(F)F]

—C(CH₃)₂—; —CH₂—; —O—;

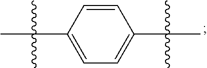 [SMILES: *c1ccc(*)cc1]

### and —S(O)₂—.

Preferably, R⁶, R⁷, R⁸, R⁹, R¹⁰, and R¹¹ are each independently hydrogen, a halogen, or fluorine.

A preferred embodiment corresponds to a benzoxazine resin prepared from bisphenol AF, 4,4′-oxydianiline, and furfurlyamine in the presence of formaldehyde. The scheme below may be used to prepare this resin:

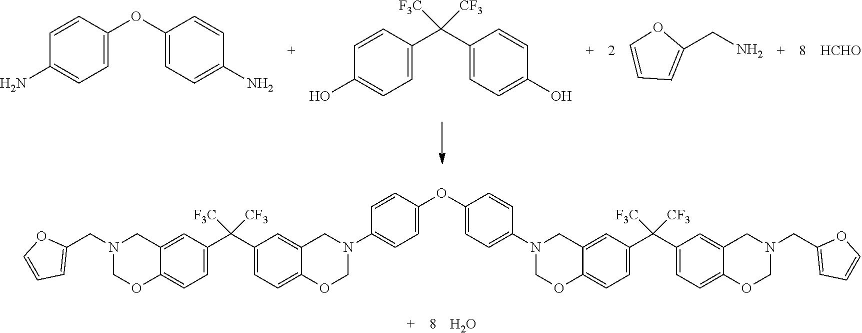 [SMILES: Nc1ccc(Oc2ccc(N)cc2)cc1 ; Oc1ccc(C(c2ccc(O)cc2)(C(F)(F)F)C(F)(F)F)cc1 ; NCc1ccco1 ; "HCHO" ; FC(F)(F)C(c1ccc2c(c1)CN(Cc1ccco1)CO2)(c1ccc2c(c1)CN(c1ccc(Oc3ccc(N4COc5ccc(C(c6ccc7c(c6)CN(Cc6ccco6)CO7)(C(F)(F)F)C(F)(F)F)cc5C4)cc3)cc1)CO2)C(F)(F)F ; O]

In some embodiments, the fluorine content of the benzoxazine resins described herein (e.g., structures (I), (II), and/or (III)) is about 15% by weight or higher, for example, at least about 16% by weight, at least about 17% by weight, at least about 18% by weight, at least about 19% by weight, at least about 20% by weight, at least about 21% by weight, at least about 22% by weight, at least about 23% by weight, at least about 24% by weight, or at least about 25% by weight.

Embodiments described herein further include polybenzoxazines prepared by polymerization, or curing, of benzoxazine resins, such as benzoxazine resins having structures (I), (II), and/or (III). Curing is defined by ASTM D883 as a method used “to change the properties of a polymeric system into a more stable, usable condition by the use of heat, radiation, or reaction with chemical additives.” Curing may be accomplished by heating of the resin, typically in a mold. Curing results in polymerization primarily through opening of the oxazine ring. Curing may result in opening of some or all of the oxazine rings in the material. Curing may be accomplished with or without catalyst and with or without initiator. One suitable catalyst is iron (III) chloride, which is effective in the range of about 0.1 to about 3.0 mol %.

Post-cure heat treatment of parts has been found to be beneficial in terms of increasing the glass transition temperature of the polymer. Exemplary embodiments have been post-cured in a convection oven, in a furnace, or on a hotplate. Heat treatment times in the range of 5 minutes to 4 hours at temperatures in the range of about 240 to about 500° C. have been found to be effective. Detailed examples of post-cure heat treatment are provided below in Examples 8 and 9.

There are a variety of methods known in the art for measurement of the glass transition temperature (Tg) of a polymer. For example, differential scanning calorimetry (DSC) may be used to determine the Tg. ASTM Standard D3418 (Standard Method for Transition Temperatures and Enthalpies of Fusion and Crystallization of Polymers by Differential Scanning calorimetry) presents such methods. Also, dynamic mechanical analysis may be used to determine the Tg. ASTM D7028 (Standard Test Method for Glass Transition Temperature (DMA Tg) of Polymer Matrix Composites by Dynamic Mechanical Analysis (DMA)) presents one such method. The Tg determined from DMA data is also dependent on the method of evaluating the data. ASTM D7028 defines the glass transition temperature as the “DMA Tg”. The DMA Tg is determined by plotting the logarithm of the storage modulus (E′) and constructing two lines that are tangent to the curve in accordance with instructions provided in ASTM D7028. The temperature at the intersection of the tangent lines is defined as the DMA Tg. Other definitions for the Tg that are commonly used include the tan delta peak (i.e., a peak in the tan delta curve) and/or the loss modulus peak (i.e., a peak in the loss modulus curve). In some instances a material may not exhibit a glass transition temperature below its thermal degradation temperature.

Embodiments described herein further include polymers and composites with unexpectedly high glass transition temperatures. Examples of composites with glass transition temperatures greater than 300° C., and in some instances greater than 500° C., are described below in Examples 10 and 14. Glass transition temperatures of the polymers and composites are also unexpectedly higher than the cure temperature. Typically, thermoset polymers exhibit glass transition temperatures that are near or below the maximum temperature used to cure the resin or to post-cure the resulting polymer.

Another aspect relates to the ability to adjust the properties of the cured polybenzoxazines through heat treatment after curing. In particular, heat treatment has unexpectedly been found to dramatically increase the Tg of the material. Heat treatment of exemplary cured composites described herein has been demonstrated to increase the Tg by 140° C. or more. The amount of increase in the Tg is especially dependent on the temperature of the heat treatment and somewhat dependent on the time. Thus, the Tg and other properties of a material may be selectively modified by post-cure heat treatment.

Other embodiments described herein include polymers and composites with unexpectedly low heat release capacity, and preferably polymers and composites with a heat release capacity about 10 J/g. K or lower. For instance, the polybenzoxazine described in Example 1 and tested as described in Example 4 below possesses a heat release capacity of about 9.0 J/g·K. The measured heat release capacity value for this composition is one of the lowest heat release capacities obtained for a polymer. Polymers with low heat release capacities typically exhibit low flammability. Embodiments described herein further include benzoxazine resins prepared with functional additives to improve performance characteristics such as reduced flammability, improved mechanical properties, increased Tg, and improved atomic oxygen erosion resistance. One suitable additive is epoxy functional polyhedral oligomeric silsesquioxane (POSS), which is effective in the range of about 0.5 to 5.0 wt. %. POSS has a combination of organic and inorganic functionality that includes a high concentration of silicon and oxygen. The epoxy functionality enables a chemical reaction during resin cure to incorporate the POSS into the polymer network. Covalent bond formation between an epoxy group and benzoxazine resins during cure has been clearly demonstrated and extensively studied. The presence of POSS, a molecular silica, in the polymer network provides for the in-situ generation of a residual protective layer in locations where some atomic oxygen erosion of the resin may occur. A detailed example of the preparation of benzoxazine resin with a POSS additive is provided in Example 6.

Other embodiments described herein include polymers and composites that exhibit unexpected behavior when tested by DMA. Polymers and composites described herein have been shown to exhibit an unusual and unexpected behavior where the storage modulus of the material increases with increasing temperature. The storage modulus has been shown to increase from room temperature up to a maximum value that typically occurs above 150° C., but may occur as high as almost 300° C. When tested by DMA, polymers typically experience a gradual reduction in storage modulus from room temperature up until a temperature near the glass transition temperature. At temperatures near or above the glass transition temperature, the storage modulus typically drops significantly. Polymers and composites described herein exhibit unusual behavior where storage modulus values at elevated temperatures are higher than those at room temperature. Examples of this behavior are provided below in Examples 10 and 14. In some instances, storage modulus values at elevated temperatures have been measured that are over 100% greater than the room temperature value. This unique behavior is desirable for applications requiring materials that maintain their mechanical properties at elevated temperatures. Parts fabricated from polymers and composites described herein are expected to have mechanical properties, at elevated temperatures of about 150° C. or higher, that are equivalent to or greater than the properties achieved at room temperature.

Yet another aspect described herein relates to polymer matrix composites prepared using benzoxazine resins. Composites may include a variety of reinforcements known in the art. Reinforcements may be added to improve mechanical properties and/or to achieve other property improvements. Reinforcing fibers, also referred to as filaments, may or may not be continuous fibers. The Composite Materials Handbook, Vol. 1 (2012) defines a continuous filament as “[a] yarn or strand in which the individual filaments are substantially the same length as the strand.” Continuous fiber reinforcement is preferred for even more advantageous mechanical properties. One preferred type of fiber reinforcement is ceramic fibers. Continuous ceramic fibers or ceramic fiber fabric reinforcements are particularly effective for improving mechanical properties and providing atomic oxygen erosion resistance. Ceramic fibers or fabrics containing alumina (Al₂O₃) and silica (SiO₂) are an especially preferred reinforcing fiber for preparing composites that are resistant to atomic oxygen erosion. Embodiments also include composites with other types of fiber reinforcement, including but not limited to, carbon fiber, boron fiber, aramid fiber (e.g., Kevlar®), polybenzimidazole fiber, basalt fiber, glass fiber, and poly(p-phenylene-benzo-bisoxazole) fiber (e.g., Zylon®). Fibers that have low flammability or are nonflammable are highly desirable for use in embodiments of the present invention.

Other embodiments described herein include composites with multiple different types of fibers. Composites that include two, three, or more different types of fibers may be prepared. The different fiber types may be placed in targeted locations of the composite in order to achieve specific benefits. For example, composite parts may be molded as a sandwich structure where very stiff or strong fibers may be placed in skin layers. Also, fibers of different types may be placed in different locations to provide additional functionality or additional mechanical strength in those locations. The unique advantages of embodiments of the composites allow such structured composites to be molded as a single part in a single molding step.

Other embodiments described herein relate to a material that includes 1% to 99% by weight of a polybenzoxazine formed by cure of a benzoxazine of a resin of structure (I), (II), or (III) as described above.

Still another aspect relates to a material, comprising:
a) 5 to 95% by volume of a polybenzoxazine formed by cure of a benzoxazine resin of the structure (I), (II), or (III) as described above; and
b) 95% to 5% by volume of fibrous reinforcement.

In a preferred aspect, the fibrous reinforcement comprises continuous fiber or woven continuous fiber.

Various additives and/or modifiers may be included in the materials, resins, polymers, and composites described herein. Additives and modifiers may include stabilizers, ultraviolet (UV) stabilizers, antioxidants, scavengers, lubricants, processing aids, antimicrobials, flame retardants, anti-blocking additives, antistatic additives, colorants, whitening agents, coupling agents, and other additives and modifiers known in the art. Fillers and reinforcements may be added. Nano particles may be included.

This invention can be further illustrated by the following examples of embodiments thereof, although it will be understood that these examples are included merely for purposes of illustration and are not intended to limit the scope of the invention unless otherwise specifically indicated.

### EXAMPLES

### Example 1: Synthesis of BAF-Oda-Fu Benzoxazine Resin

BAF-oda-fu resin monomer was synthesized using the following procedure. Bisphenol AF, 4,4′-oxydianiline, furfurylamine, and paraformaldehyde were combined in a round-bottom flask in stoichiometric ratios of 2:1:2:8, respectively. Chloroform was added to the round bottom flask. The solution was heated for 12 hours at 90° C. while being continuously stirred. The chloroform was evaporated under air for 10 days, after which the product was moved to a vacuum oven to continue drying at 50° C. for 11 hours. Once dry, the product underwent a total of seven washes to remove impurities-three washes with a 1 N NaOH aqueous solution followed by four washes with water. The washed product was then dried under air to obtain a yellowish granular solid. Yields before and after purification were approximately 92% and 85%, respectively. The resulting product was stored in a freezer at approximately-18° C. The resin was polymerized by different means, including the means described in examples that follow. The weight percentage of fluorine in this resin is approximately 19.6%, both before and after cure.

### Example 2: Polymerization of BAF-Oda-Fu Benzoxazine

This example describes the polymerization of approximately 3 grams of neat resin prepared by the method of Example 1. Neat BAF-oda-fu resin was removed from a storage jar and added to a silicone mold using a spatula. The mold was placed in a vacuum oven at room temperature. A vacuum of approximately 760 mm of mercury (Hg) was applied and held for 24 hours to remove moisture. The vacuum was released and the oven temperature was increased to approximately 160° C. The temperature was held at 160° C. for 40 minutes. While holding the temperature steady at 160° C., vacuum was reapplied for 20 minutes and then released. The oven temperature was increased to 200° C. and held for two hours. The mold was removed from the oven and allowed to cool at room temperature. The molded part was removed from the mold and found to be a solid polymer with a density of approximately 1.38 g/cm³ (as determined in accordance with ASTM D792).

### Example 3: Thermogravimetric Analysis of Poly(BAF-Oda-Fu)

This example describes the thermogravimetric analysis of a sample of poly(BAF-oda-fu) to evaluate its thermal degradation characteristics. Thermogravimetric analysis (TGA) was conducted using a TA Instruments model 2950 TGA with a heating rate of 10° C./minute over a temperature range of room temperature to 800° C. The sample was tested in an inert nitrogen atmosphere using a nitrogen flow rate of 60 mL/minute. The resulting TGA thermogram is shown in FIG. 1. The char yield at 800° C. was measured to be 24% for poly(BAF-oda-fu).

### Example 4: Microscale Combustion Calorimetry Testing of Poly(BAF-Oda-Fu)

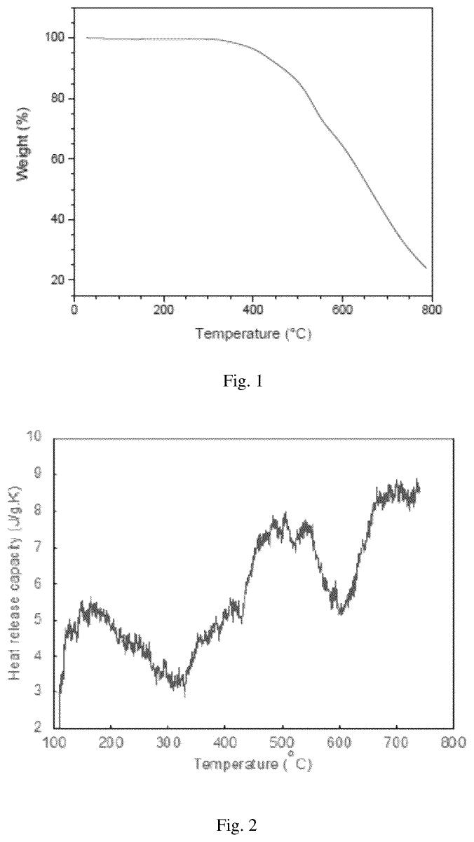

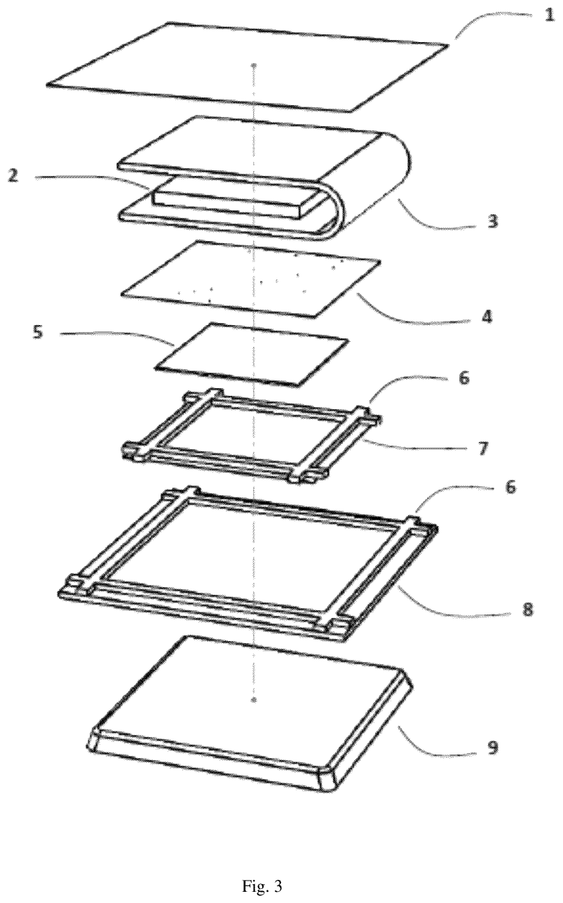

This example describes the testing of a sample of poly(BAF-oda-fu) in a microscale combustion calorimeter manufactured by Fire Testing Technology. Testing was guided by ASTM D7309. The polymer sample was heated at a rate of 1.0° C./second from room temperature to about 800° C. Specific heat release rate/heating rate was measured as a function of temperature and is plotted in FIG. 2. The maximum value of specific heat release rate/heating rate, measured to be approximately 9 J/g. K, was determined as the material's heat release capacity (HRC) in accordance with the definition provided in ASTM D7309. This example illustrates the unusually low heat release capacity achievable in embodiments of the present invention.

### Example 5: Composite of Poly(BAF-Oda-Fu) and Ceramic Fiber Fabric

This example describes the fabrication of a composite plate containing one 10×10 cm piece of ceramic fiber fabric reinforcement and poly(BAF-oda-fu) polymer. The fabric was purchased from a commercial source and was comprised of woven 3M Nextel® 312 ceramic fibers. The fabric technical specification identifies the areal density as 810 g/m² and the yarn denier as 1800 for both the warp and fill direction. The fabric surface was heat cleaned by the supplier to remove sizing and organic coatings from fiber surfaces. The density of Nextel® 312 fiber is reported as 2.8 g/cm³ by the manufacturer.

Approximately 6 grams of neat BAF-oda-fu resin, prepared as described in Example 1, was applied to the surfaces of the ceramic fabric using a spatula. Consolidation and polymerization of the composite were achieved by simultaneously applying vacuum and heat while sealed in a vacuum bagged mold, as illustrated in FIG. 3. A one-sided mold was constructed using a 30.5×30.5×1.0 cm polished aluminum plate 8, vacuum bagging film 1, perforated release film 4, non-perforated release film 7, breather/bleeder cloth 3, vacuum sealing tape 6 and a 10×10×1.0 cm aluminum pressure plate 2 according to the schematic provided in FIG. 3. The un-cured composite 5 was hand laid into the mold during assembly. Vacuum tubing was connected to the mold using a through-bag vacuum fitting placed below the vacuum bagging film and on top of the breather/bleeder cloth. Full vacuum of approximately 760 mm Hg was applied 24 hours prior to the start of the polymerization cycle.

The aluminum plate was heated by placing it directly on the surface of a hotplate with a 26×26 cm ceramic top 9. Composite temperature was monitored using a thermocouple that was placed on the surface of the aluminum plate under a corner of the composite. The composite was polymerized using the following cure schedule: 30 minutes at a hotplate setpoint of 150° C., 20 minutes at a hotplate setpoint of 170° C., 30 minutes at a hotplate setpoint of 200° C., and 1 hour and 45 minutes at a hotplate setpoint of 215° C. The maximum temperature reached by the composite, according to the thermocouple, was 203.8° C. After completion of the polymerization cycle, the hot plate was turned off and the mold was allowed to cool. Vacuum was continuously applied during cooling to prevent the composite from warping. Vacuum was released once the thermocouple temperature dropped below 60° C.

The composite plate was inspected after removal from the mold. It appeared to be fully polymerized and showed no signs of defects. The plate was flat with a nominal thickness of 1.0 mm. The mass of the resulting composite plate was approximately 13.0 grams. Based on the known mass of the dry fabric reinforcement, which was measured to be 8.7 grams prior to composite processing, the mass fractions of poly(BAF-oda-fu) and ceramic fiber reinforcement in the composite were calculated to be approximately 33.1% and 66.9%, respectively. A rectangular sample, approximately 60×12 mm in size, was cut from the composite plate using a laser cutter and designated as “Sample A.”

### Example 6: Preparation of BAF-Oda-Fu Benzoxazine Containing POSS Additive

This example describes the preparation of approximately 15.0 grams of BAF-oda-fu benzoxazine resin containing 3 wt. % POSS additive (EP0418 glycidylisobutyl POSS, CAS No. 444315-17-7, Hybrid Plastics Inc., Hattiesburg, MS, USA). Approximately 14.55 grams of BAF-oda-fu resin and 14.55 grams of tetrahydrofuran (THF) were combined in a glass beaker. The 50 wt. % BAF-oda-fu/THE solution was mechanically stirred at room temperature for 30 minutes. In a separate beaker, approximately 1.0 grams of POSS and 9.0 grams of THF were combined to form a 10 wt. % POSS/THE solution. The solution was mechanically stirred at room temperature for 30 minutes. Approximately 4.5 grams of the 10 wt. % POSS/THE solution was then added to the beaker containing the 50 wt. % BAF-oda-fu/THF solution. The resulting mixture was mechanically stirred at room temperature for 30 minutes. The mixture was then poured into a non-stick pan, approximately 18×28 cm in size, and placed under a fume hood. The solvent was allowed to evaporate at room temperature under the fume hood. After a period of five days, the remaining solid resin, abbreviated as BAF-oda-fu-POSS, was removed from the non-stick pan using a plastic spatula and placed into a glass bottle for storage. The resulting product was stored in a freezer at approximately −18° C. until needed for use.

### Example 7: Composite of Poly(BAF-Oda-Fu-POSS) w/3 wt. % POSS Additive and Ceramic Fabric

This example describes the fabrication of a composite plate containing one 10×10 cm piece of ceramic fiber fabric reinforcement and poly(BAF-oda-fu-POSS) polymer w/3 wt. % POSS additive. A batch of BAF-oda-fu-POSS resin containing 3 wt. % POSS additive was prepared in accordance with the procedure identified in Example 6. The same woven ceramic fabric described previously in Example 5 was used in this example as well.

Approximately 6 grams of BAF-oda-fu-POSS resin w/3 wt. % POSS additive was applied to the top surface of the ceramic fabric using a spatula. Consolidation and polymerization of the composite were achieved by simultaneously applying vacuum and heat while sealed in a vacuum bagged mold, as illustrated in FIG. 3. Components of the mold used in this example were the same as those described previously in Example 5. Vacuum tubing was connected to the mold using a through-bag vacuum fitting as described previously in Example 5. Full vacuum of approximately 760 mm Hg was applied 24 hours prior to the start of the polymerization cycle.

The aluminum plate was heated by placing it directly on the surface of a hotplate with a 26×26 cm ceramic top. Composite temperature was monitored using a thermocouple that was placed on the surface of the aluminum plate under a corner of the composite. The composite was polymerized using the following cure schedule: 50 minutes at a hotplate setpoint of 150° C. followed by 2 hours and 30 minutes at a hotplate setpoint of 215° C. After completion of the polymerization cycle, the hot plate was turned off and the mold was allowed to cool. Vacuum was continuously applied during cooling to prevent the composite from warping. Vacuum was released once the thermocouple temperature reached room temperature.

The composite plate was inspected after removal from the mold. It appeared to be fully polymerized and showed no signs of defects. The plate was flat with a nominal thickness of 1.0 mm. The mass of the resulting composite plate was approximately 12.3 grams. Based on the known mass of the dry fabric reinforcement, which was measured to be 8.7 grams prior to composite processing, the mass fractions of poly(BAF-oda-fu-POSS) and ceramic fiber reinforcement in the composite were calculated to be approximately 29.3% and 70.7%, respectively.

### Example 8: Post-Cure Heat Treatment of Composite of Poly(BAF-Oda-Fu) and Ceramic Fiber Fabric

This example describes the process of heat treating a sample of the composite plate comprised of poly(BAF-oda-fu) and ceramic fiber fabric that was prepared previously in Example 5. Heat was applied to the composite using a laboratory convection oven. Composite temperature was monitored using a thermocouple that was placed in contact with the surface of the composite. The composite was heated for 30 minutes at 240° C. The composite was removed from the oven and allowed to cool to room temperature. A rectangular sample, approximately 60×12 mm in size, was cut from the composite plate using a laser cutter and designated as “Sample B.”

### Example 9: Post-Cure Heat Treatment of Composite of Poly(BAF-Oda-Fu-POSS) w/3 wt. % POSS Additive and Ceramic Fiber Fabric

This example describes the process of heat treating a composite plate comprised of poly(BAF-oda-fu-POSS) w/3 wt. % POSS and ceramic fiber fabric that was prepared previously in Example 7. Heat was applied to the composite using a hotplate with a 26×26 cm ceramic top. The composite plate from Example 7 was placed between two sheets of release film and then placed on a large aluminum plate (approximately 30.5×30.5×1.0 cm in size). The aluminum plate was placed on the surface of the ceramic hotplate. A second aluminum plate was then placed on the top surface of the upper release layer. A 4.5 kg weight was placed on top of the aluminum plate to increase down pressure and minimize warping. Composite temperature was monitored using a thermocouple that was placed on the surface of the aluminum plate under a corner of the composite. The hotplate temperature was increased from room temperature to 240° C. The composite was heated for 30 minutes at 240° C. The hotplate was turned off and the composite was allowed to cool to room temperature. A rectangular sample, approximately 60×12 mm in size, was cut from the composite plate using a laser cutter and designated as “Sample C.”

### Example 10: Dynamic Mechanical Analysis of Composite Samples with Ceramic Fiber Reinforcement

This example describes dynamic mechanical analysis (DMA) testing of composite samples with ceramic fiber reinforcement. Rectangular samples, approximately 60×12 mm in size, were previously cut from composite plates and designated as Samples A through C, as described in Examples 5, 8, and 9. All samples were tested using a TA Instruments model Q800 DMA equipped with a dual cantilever fixture. Test parameters were guided by ASTM D7028. Samples were tested at a constant strain amplitude of 0.1% and frequency of 1.0 Hz. Temperature was ramped from room temperature to a maximum value ranging from 300 to 600° C. at a rate of 5° C./minute.

The composite sample, designated as “Sample A”, that was cut from the composite plate prepared in Example 5 with no heat treatment was tested by DMA to determine its glass transition temperature. The sample was tested to a maximum temperature of 300° C. using the parameters described above. The DMA Tg, loss modulus peak, and tan delta peak were found to be 239° C., 268° C., and 271° C., respectively. The storage modulus was observed to increase with increasing temperature from a value of 6.24 GPa at 22° C. to a maximum value of 8.47 GPa at 153° C.; an increase of 2.23 GPa or 35.7%.

The composite sample, designated as “Sample B”, that was cut from the composite plate prepared in Example 5 and heat treated for 30 minutes at 240° C. in Example 8 was tested by DMA to determine its glass transition temperature. The sample was tested to a maximum temperature of 450° C. using the parameters described above. The DMA Tg, loss modulus peak, and tan delta peak were found to be 273° C., 299° C., and 310° C., respectively. The storage modulus was observed to increase with increasing temperature from a value of 6.09 GPa at 24° C. to a maximum value of 10.7 GPa at 261° C.; an increase of 4.58 GPa or 75.3%. Sample B illustrates the use of post-cure heat treatment to alter the properties of the material, including increasing the glass transition temperature. This sample also illustrates the achievement of a glass transition temperature of about 300° C. or higher in the present invention.

The composite sample, designated as “Sample C”, that was cut from the composite plate prepared in Example 7 and heat treated for 30 minutes at 240° C. in Example 9 was tested by DMA to determine its glass transition temperature. The sample was tested to a maximum temperature of 450° C. using the parameters described above. The DMA Tg and loss modulus peak were found to be 308° C. and 336° C., respectively. The tan delta peak was not observed at the maximum test temperature of 450° C. The storage modulus was observed to increase with increasing temperature from a value of 6.00 GPa at 22° C. to a maximum value of 12.6 GPa at 254° C.; an increase of 6.55 GPa or 109.1%. Sample C illustrates the use of post-cure heat treatment to alter the properties of the material, including increasing the glass transition temperature. This sample also illustrates the achievement of a glass transition temperature of about 300° C. or higher in the present invention.

Sample C was retested by DMA to a maximum temperature of 600° C. The additional heat treatment from the first DMA test was found to further increase the glass transition temperature. The retested sample was designated as “Sample C (2nd Test).” The DMA Tg, loss modulus peak, and tan delta peak were found to be 467° C., 501° C., and 543° C., respectively. The storage modulus was observed to increase with increasing temperature from a value of 4.39 GPa at 23° C. to a maximum value of 9.76 GPa at 247° C.; an increase of 5.37 GPa or 122.3%. Sample C (2nd test) illustrates the use of post-cure heat treatment to alter the properties of the material, including increasing the glass transition temperature. This sample also illustrates the achievement of a glass transition temperature of about 460° C. or higher in the present invention.

Results from the DMA testing conducted in Example 10 are summarized in Table 1.

TABLE 1
Summary of DMA Results for Composite Samples
Containing Ceramic Fiber Reinforcement

| | | | | Sample C |
|---|---|---|---|---|
| Sample ID | Sample A | Sample B | Sample C | (2nd Test) |
| Post-Cure Heat | None | 30 min at | 30 min at | 30 min at |
| Treatment | | 240° C. | 240° C. | 240° C. plus |
| | | | | heating from |
| | | | | room temp to |
| | | | | 450° C. at |
| | | | | 5° C./min |
| | | | | during 1st |
| | | | | DMA test |
| DMA Tg | 239° C. | 273° C. | 308° C. | 467° C. |
| Loss Modulus Peak | 268° C. | 299° C. | 336° C. | 501° C. |
| Tan Delta Peak | 271° C. | 310° C. | Peak not | 543° C. |
| | | | observed | |
| Storage Modulus | 6.24 GPa | 6.09 GPa | 6.00 GPa | 4.39 GPa |
| at Minimum Test | at 22° C. | at 24° C. | at 22° C. | at 23° C. |
| Temperature | | | | |

### Example 11: Prepregs of Poly(BAF-Oda-Fu) and Carbon Fiber Fabric

This example describes the preparation of prepregs comprised of carbon fiber fabric and BAF-oda-fu resin. To prepare the prepregs, four swatches of carbon fiber fabric, approximately 10×10 cm in size, were obtained from a larger roll fabric using a handheld rotary cutter. The total mass of the four fabric swatches was 8.11 grams. The fabric was purchased from a commercial source and was comprised of woven Hexcel® HexTow® AS4 carbon fibers. The fabric technical specification identifies the areal density as 193 g/m² and filament count per tow as 3000. The density of HexTow® AS4 carbon fiber is reported as 1.79 g/cm³ by the manufacturer.

Approximately 7.15 grams of BAF-oda-fu resin, previously prepared in Example 1, was dissolved in acetone to form a mixture with approximately a 20:80 ratio of resin to acetone by weight. The mixture of resin and acetone was stirred at room temperature for approximately 15 minutes. The mixture was then applied to the surfaces of the four carbon fiber fabric swatches using a glass pipette. The mixture was distributed evenly between the surfaces of the four fabric swatches and applied in several steps so as to not oversaturate the fabric. Approximately 10-15 minutes of drying time was allowed under a fume hood between applications. After the final application, the prepregs were placed into a vacuum oven and dried at room temperature for 24 hours under a vacuum of approximately 760 mm Hg. The average mass of resin in the prepregs after drying was 38.5%.

### Example 12: Composite of Poly(BAF-Oda-Fu) and Carbon Fiber Fabric

This example describes the fabrication of a composite plate using the carbon fiber prepregs that were previously prepared in Example 11. Consolidation and polymerization of the composite were achieved by simultaneously applying vacuum and heat while sealed in a vacuum bagged mold, as illustrated in FIG. 3. Components of the mold used in this example were the same as those described previously in Example 5. Prepregs were hand laid into the mold during assembly. Vacuum tubing was connected to the mold using a through-bag vacuum fitting as described previously in Example 5.

The aluminum plate was heated by placing it directly on the surface of a hotplate with a 26×26 cm ceramic top. The composite temperature was monitored using a thermocouple that was placed on the surface of the aluminum plate under a corner of the prepregs. The composite was polymerized using the following cure schedule: 45 minutes at a hotplate setpoint of 150° C. followed by 2 hours and 15 minutes at a hotplate setpoint of 210° C. The maximum temperature reached by the composite, according to the thermocouple, was 199.5° C. After completion of the polymerization cycle, the hot plate was turned off and the mold was allowed to cool. Vacuum was continuously applied during cooling to prevent the composite from warping. Vacuum was released once the thermocouple temperature dropped below 60° C.

The composite plate was inspected after removal from the mold. It appeared to be fully polymerized and showed no signs of defects. The plate was flat with a nominal thickness of 1.0 mm. The mass of the resulting composite plate was approximately 12.3 grams. Based on the known mass of the dry fabric reinforcement, which was measured to be 8.11 grams prior to prepreg preparation, the mass fractions of poly(BAF-oda-fu) and carbon fiber reinforcement in the composite were calculated to be approximately 33.8% and 66.2%, respectively. A rectangular sample, approximately 60×12 mm in size, was cut from the composite plate using a wet saw with a diamond blade and designated as “Sample D.”

### Example 13: Post-Cure Heat Treatment of Composite of Poly(BAF-Oda-Fu) and Carbon Fiber Fabric

This example describes the process of heat treating samples from a composite plate comprised of poly(BAF-oda-fu) and carbon fiber fabric that was prepared previously in Example 12. Samples, approximately 60×12 mm in size, were cut from the composite plate using a wet saw with a diamond blade. Heat was applied to the composite samples using a laboratory convection oven.

Three composite samples were heat treated at 260° C. The composite samples were placed into a preheated oven and then removed after the specified heat treatment time had elapsed and allowed to cool to room temperature. One sample was heat treated for 1 hour at 260° C. and was designated as “Sample E.” One sample was heated for 2 hours at 260° C. and was designated as “Sample F.” One sample was heated treated for 4 hours at 260° C. and was designated as “Sample G.”

Two composite samples were heat treated at 300° C. The composite samples were placed into a preheated oven and then removed after the specified heat treatment time had elapsed and allowed to cool to room temperature. One sample was heat treated for 1 hour at 300° C. and was designated as “Sample H.” One sample was heat treated for 2 hours at 300° C. and was designated as “Sample I.”

### Example 14: Dynamic Mechanical Analysis of Composite Samples with Carbon Fiber Reinforcement

This example describes dynamic mechanical analysis (DMA) testing of composite samples with carbon fiber reinforcement. Rectangular samples, approximately 60×12 mm in size, were previously cut from the composite plate prepared in Example 12 and designated as Samples D through I, as described in Examples 12 and 13. All samples were tested using a TA Instruments model Q800 DMA equipped with a dual cantilever fixture. Test parameters were guided by ASTM D7028. Samples were tested at a constant strain amplitude of 0.1% and frequency of 1.0 Hz. Temperature was ramped from room temperature to a maximum value ranging from 350 to 600° C. at a rate of 5° C./minute.

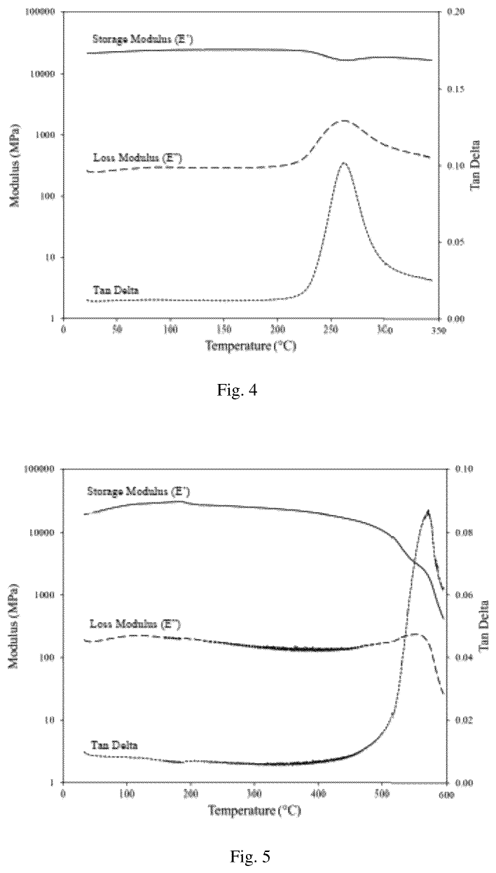

The composite sample, designated as “Sample D”, that was cut from the composite plate prepared in Example 12 with no heat treatment was tested by DMA to determine its glass transition temperature. The sample was tested to a maximum temperature of 350° C. using the parameters described above. A plot of the storage modulus, loss modulus, and tan delta versus temperature for Sample D is provided in FIG. 4. The DMA Tg, loss modulus peak, and tan delta peak were found to be 226° C., 262° C., and 262° C., respectively. The storage modulus was observed to increase with increasing temperature from a value of 21.6 GPa at 22° C. to a maximum value of 24.8 GPa at 161° C.; an increase of 3.18 GPa or 14.7%.

The composite sample, designated as “Sample E”, that was cut from the composite plate prepared in Example 12 and heat treated for 1 hour at 260° C. in Example 13 was tested by DMA to determine its glass transition temperature. The sample was tested to a maximum temperature of 500° C. using the parameters described above. The DMA Tg, loss modulus peak, and tan delta peak were found to be 370° C., 402° C., and 406° C., respectively. The storage modulus was observed to increase with increasing temperature from a value of 20.2 GPa at 26° C. to a maximum value of 24.6 GPa at 228° C.; an increase of 4.50 GPa or 22.3%. Sample E illustrates the use of post-cure heat treatment to alter the properties of the material, including increasing the glass transition temperature. This sample also illustrates the achievement of a glass transition temperature of about 370° C. or higher in the present invention.

Sample E was retested by DMA to a maximum temperature of 600° C. using the same parameters as the first test. The additional heat treatment from the first DMA test was found to increase the glass transition temperature and the maximum storage modulus. The retested sample was designated as “Sample E (2nd Test).” A plot of the storage modulus, loss modulus, and tan delta versus temperature for Sample E (2nd Test) is provided in FIG. 5. The DMA Tg, loss modulus peak, and tan delta peak were found to be 505° C., 552° C., and 571° C., respectively. The storage modulus was observed to increase with increasing temperature from a value of 19.6 GPa at 33° C. to a maximum value of 30.8 GPa at 184° C.; an increase of 11.2 GPa or 57.3%. Sample E (2nd test) illustrates the use of post-cure heat treatment to alter the properties of the material, including increasing the glass transition temperature. This sample also illustrates the achievement of a glass transition temperature of about 500° C. or higher in the present invention.

The composite sample, designated as “Sample F”, that was cut from the composite plate prepared in Example 12 and heat treated for 2 hours at 260° C. in Example 13 was tested by DMA to determine its glass transition temperature. The sample was tested to a maximum temperature of 500° C. using the parameters described above. The DMA Tg, loss modulus peak, and tan delta peak were found to be 373° C., 400° C., and 404° C., respectively. The storage modulus was observed to increase with increasing temperature from a value of 20.5 GPa at 23° C. to a maximum value of 26.2 GPa at 220° C.; an increase of 5.70 GPa or 27.8%. Sample F illustrates the use of post-cure heat treatment to alter the properties of the material, including increasing the glass transition temperature. This sample also illustrates the achievement of a glass transition temperature of about 370° C. or higher in the present invention.

The composite sample, designated as “Sample G”, that was cut from the composite plate prepared in Example 12 and heat treated for 4 hours at 260° C. in Example 13 was tested by DMA to determine its glass transition temperature. The sample was tested to a maximum temperature of 500° C. using the parameters described above. The DMA Tg, loss modulus peak, and tan delta peak were found to be 377° C., 400° C., and 405° C., respectively. The storage modulus was observed to increase with increasing temperature from a value of 22.9 GPa at 27° C. to a maximum value of 28.8 GPa at 172° C.; an increase of 5.91 GPa or 25.8%. Sample G illustrates the use of post-cure heat treatment to alter the properties of the material, including increasing the glass transition temperature. This sample also illustrates the achievement of a glass transition temperature of about 370° C. or higher in the present invention.

The composite sample, designated as “Sample H”, that was cut from the composite plate prepared in Example 12 and heat treated for 1 hour at 300° C. in Example 13 was tested by DMA to determine its glass transition temperature. The sample was tested to a maximum temperature of 500° C. using the parameters described above. The DMA Tg, loss modulus peak, and tan delta peak were found to be 335° C., 401° C., and 403° C., respectively. The storage modulus was observed to increase with increasing temperature from a value of 21.3 GPa at 23° C. to a maximum value of 27.2 GPa at 280° C.; an increase of 5.96 GPa or 28.0%. Sample H illustrates the use of post-cure heat treatment to alter the properties of the material, including increasing the glass transition temperature. This sample also illustrates the achievement of a glass transition temperature of about 330° C. or higher in the present invention.

The composite sample, designated as “Sample I”, that was cut from the composite plate prepared in Example 12 and heat treated for 2 hours at 300° C. in Example 13 was tested by DMA to determine its glass transition temperature. The sample was tested to a maximum temperature of 500° C. using the parameters described above. The DMA Tg, loss modulus peak, and tan delta peak were found to be 335° C., 396° C., and 405° C., respectively. The storage modulus was observed to increase with increasing temperature from a value of 19.8 GPa at 23° C. to a maximum value of 26.5 GPa at 273° C.; an increase of 6.75 GPa or 34.1%. Sample I illustrates the use of post-cure heat treatment to alter the properties of the material, including increasing the glass transition temperature. This sample also illustrates the achievement of a glass transition temperature of about 330° C. or higher in the present invention.

Results from the DMA testing conducted during Example 14 are summarized in Table 2.

TABLE 2
Summary of DMA Results for Composite Samples Containing Carbon Fiber Reinforcement

| | | | Sample E | | | | |
|---|---|---|---|---|---|---|---|
| Sample ID | Sample D | Sample E | (2nd Test) | Sample F | Sample G | Sample H | Sample I |
| Post-Cure | None | 1 hr at | 1 hr at | 2 hr at | 4 hr at | 1 hr at | 2 hr at |
| Heat | | 260° C. | 260° C. | 260° C. | 260° C. | 300° C. | 300° C. |
| Treatment | | | plus | | | | |
| | | | heating | | | | |
| | | | from | | | | |
| | | | 26° C. to | | | | |
| | | | 500° C. at | | | | |
| | | | 5° C./min | | | | |
| | | | during | | | | |
| | | | 1st DMA | | | | |
| | | | test | | | | |
| DMA Tg | 226° C. | 370° C. | 505° C. | 373° C. | 377° C. | 335° C. | 335° C. |
| Loss | 262° C. | 402° C. | 552° C. | 400° C. | 400° C. | 401° C. | 396° C. |
| Modulus | | | | | | | |
| Peak | | | | | | | |
| Tan Delta | 262° C. | 406° C. | 571° C. | 404° C. | 405° C. | 403° C. | 405° C. |
| Peak | | | | | | | |
| Storage | 21.6 GPa | 20.1 GPa | 19.6 GPa | 20.5 GPa | 22.9 GPa | 21.3 GPa | 19.8 GPa |
| Modulus at | at 22° C. | at 26° C. | at 33° C. | at 23° C. | at 27° C. | at 23° C. | at 23° C. |
| Minimum | | | | | | | |
| Test | | | | | | | |
| Temperature | | | | | | | |

For the avoidance of doubt, it is noted that the invention relates to all possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition and process according to the invention are described herein.

The invention has been described in detail with particular reference to the preferred embodiments thereof, but it will be understood that variations and modifications can be effected within the spirit and scope of the invention.

1. A benzoxazine resin of structure (I): 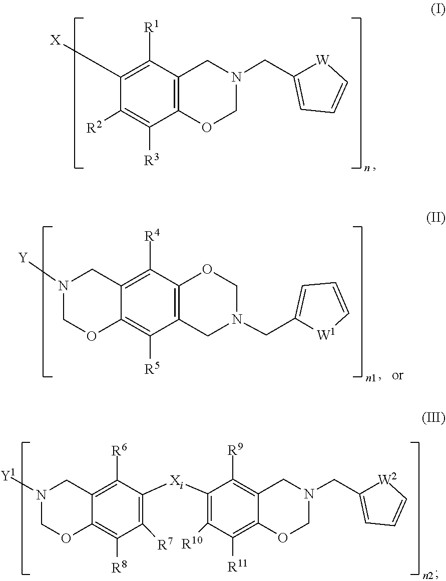
wherein
X and Y each independently include at least one fluorine moiety;
at least one of Y¹ or Xi includes at least one fluorine moiety;
n, n1, and n2 are each independently equal to or greater than 1 and equal to or less than 4;
W. W¹, and W² are each independently oxygen or sulfur;
R¹, R², R³, R⁴, R⁵, R⁶, R⁷, R⁸, R⁹, R¹⁰, and R¹¹ are each independently hydrogen, a halogen, an alkyl group, an alkyl group with one or more halogen substituents, an alkenyl group, an alkenyl group with one or more halogen substituents, an aryl group, or an aryl group with one or more halogen substituents; and
the fluorine content of the resin is about 15% by weight or higher.

2. The benzoxazine resin of claim 1, wherein R¹, R², R³, R⁴, R⁵, R⁶, R⁷, R⁸, R⁹, R¹⁰, and R¹¹ are each independently hydrogen, a halogen, a C₁-C₈ alkyl group, a C₁-C₈ alkyl group with one or more halogen substituents, a C₂-C₄ alkenyl group, a C₂-C₄ alkenyl group with one or more halogen substituents, a C₆-C₁₃ aryl group, or a C₆-C₁₃ aryl group with one or more halogen substituents.

3. The benzoxazine resin of claim 1, wherein the fluorine content of the resin is about 19% by weight or higher.

4. The benzoxazine resin of claim 1, wherein n, n1, and n2 each independently =2.

5. The benzoxazine resin of claim 1, wherein each of R¹, R², R³, R⁴, R⁵, R⁶, R⁷, R⁸, R⁹, R¹⁰, and R¹¹ is independently hydrogen.

6. A polybenzoxazine formed by cure of benzoxazine resin of
of claim 1, wherein at least one of: (i) the polybenzoxazine has a glass transition temperature of about 300° C. or higher, (ii) the polybenzoxazine does not exhibit a glass transition temperature below its thermal degradation temperature, or (iii) the polybenzoxazine has a heat release capacity of about 10 J/g·K or lower.

7. The polybenzoxazine of claim 6, wherein R¹, R², R³, R⁴, R⁵, R⁶, R⁷, R⁸, R⁹, R¹⁰, and R¹¹ are each independently hydrogen, a halogen, a C₁-C₈ alkyl group, a C₁-C₈ alkyl group with one or more halogen substituents, a C₂-C₄ alkenyl group, a C₂-C₄ alkenyl group with one or more halogen substituents, a C₆-C₁₃ aryl group, or a C₆-C₁₃ aryl group with one or more halogen substituents.

8. The polybenzoxazine of claim 6, wherein n, n1, and n2 each independently =2.

9. The polybenzoxazine of claim 6, wherein each of R¹, R², R³, R⁴, R⁵, R⁶, R⁷, R⁸, R⁹, R¹⁰, and R¹¹ is independently hydrogen.

10-13. (canceled)

14. A material, comprising:
a) 5 to 95% by volume of a polybenzoxazine formed by cure of benzoxazine resin of claim 1; and
b) 95% to 5% by volume of fibrous reinforcement.

15-32. (canceled)

33. The benzoxazine resin of claim 1, wherein n2 is equal to or greater than 2 and equal to or less than 4 and each Xi is the same moiety.

34. The benzoxazine resin of claim 1, wherein n2=2; W² is oxygen; each of R⁶, R⁷, R⁸, R⁹, R¹⁰, and R¹¹ is hydrogen; Y¹ is 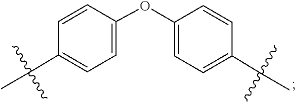 [SMILES: *c1ccc(Oc2ccc(*)cc2)cc1]
and each of X₁ and X₂ is —C(CF₃)₂—.

35-44. (canceled)

45. The material of claim 14, wherein
the polybenzoxazine has a glass transition temperature of about 300° C. or higher or the polybenzoxazine does not exhibit a glass transition temperature below its thermal degradation temperature.

46. A method of forming a polybenzoxazine, the method comprising:
heating a benzoxazine resin of claim 1 to a temperature and for a duration of time effective to the cure the benzoxazine resin and form the polybenzoxazine.

47. The method of claim 46, wherein the benzoxazine resin is heated in the presence of an iron (III) chloride catalyst.

48. The method of claim 46, wherein the benzoxazine resin is heated in the presence of an iron (III) chloride catalyst at a concentration of about 0.1 mol. % to about 3.0 mol. %.

49. The method of claim 46, further comprising heating the cured polybenzoxazine to a second temperature and for a duration of time effective to increase the glass transition temperature of the polybenzoxazine.

50. The method of claim 49, wherein the second temperature is greater than the temperature used to cure the benzoxazine resin but less than the glass transition temperature.

51. The method of claim 49, wherein the second temperature is about 240° C. to about 500° C.

52. The method of claim 49, wherein the glass transition temperature is at least about 300° C.

53-56. (canceled)
